(19) United States
(12) Patent Application Publication
(10) Pub. No.: US 2007/0027673 A1
(43) Pub. Date: Feb. 1, 2007

(54) Conversion of number into text and speech

(76) Inventor: Marko Moberg, Kangasala (FI)

Correspondence Address: Hollingsworth & Funk, LLC, Suite 125, 8009 34th Avenue South, Minneapolis, MN, 55425, US

(21) Appl. No.: 11/193,028

(22) Filed: Jul. 29, 2005

(51) Int. Cl. G06F 17/27

(52) U.S. Cl. 704/9

(57) ABSTRACT

A solution for converting a cardinal number into a textual representation or into speech is presented. A converter converts, one by one, each digit of the cardinal number into a textual representation. A combiner adds a textual representation of a place value to a textual representation of a digit depending on a place of a digit. A corrector corrects, on the basis of language-dependent rules defining correct expressions, any formed textual representation relating to at least one digit having a textual representation different from a correct expression, and combines the textual representations for forming a full textual representation of the number. A synthesizer converts the full textual representation of the number into speech.

### FIELD

The invention relates to conversion of a number into a textual form and further to speech.

### BACKGROUND

Written text can be converted into speech by a text-to-speech system which may be applied e.g. to multimedia, speaking website, message reading (e-mail, SMS), user interfaces for handsfree/eyesfree devices (navigation, mobile phones), automated context aware announcement systems (anything involving varying data, telephone services) and aids for the visually impaired.

A text pre-processor or text normalizer of a TTS system controls that all the information input to the TTS system can be presented properly with normal characters. The characters are further processed to create the corresponding pronunciations. However, numerical pieces of information such as “1”, “45”, “363” do not contain any clues about the pronunciation and hence the pronunciation has to be generated separately. One way to do it is to convert numbers into a textual representation. A number as text can then be pronounced using rules or look-up tables as in the case of any other non-numerical information using text strings: “1”→“one”, “45”→“forty-five”, etc.

Naturally, numbers have different textual representations in each language. Furthermore, the construction of a text string differs from one language to another. For example, in English “forty-three” contains words for the number “40” and “3”, in Finnish “neljäkymmentäkolme” contains words for “4”, “kymmentä” indicating tens and “3”. Number “74” in French would be “soixante-dix-quatre” which equals “60”, “10” and “4”.

Cardinal numbers present a special case of input to a TTS system. Pronunciations of each number separately cannot be stored in a look-up table, if the range of the required numbers is large. The size of the table for supporting numbers from 1 to 99999, for instance, is too huge.

Some rule-based approaches have been proposed for converting a number to text. However, the proposed solutions have many problems. Typically they are language-specific, and hence can convert a number into one language only. They are also typically based on complicated mathematics requiring, for example, modulo calculation. All in all, known rule-based approaches are both methodically and structurally complicated.

Therefore, a need exists for a simple solution for constructing a textual representation of a cardinal number. The solution should also be applicable to a plurality of languages.

### BRIEF DESCRIPTION OF THE INVENTION

An object of the invention is to provide an improved solution for converting a number into text. According to an aspect of the invention, there is provided a method of converting a cardinal number of a decimal number system including at least one digit in a sequence of places ordered by powers of ten into a textual representation of a desired language, the method comprising: converting, one by one, each digit of the cardinal number into a textual representation of a desired language; performing the following operation depending on a place of a digit in the sequence of places ordered by powers of ten: adding a textual representation of a place value to a textual representation of a digit; and performing additionally the following operation in the basis of language-dependent rules defining correct expressions: correcting any formed textual representation relating to at least one digit in a place known to result in a textual representation differing from a correct expression.

According to another aspect of the invention, there is provided a method of converting a cardinal number of a decimal number system including at least one digit in a sequence of places ordered by powers of ten into speech of a desired language, the method comprising: converting, one by one, each digit of the cardinal number into a textual representation of a desired language; performing the following operation depending on a place of a digit in the sequence of places ordered by powers of ten: adding a textual representation of a place value to a textual representation of a digit; performing additionally the following operation on the basis of language-dependent rules defining correct expressions: correcting any formed textual representation relating to at least one digit in a place known to result in a textual representation differing from a correct expression; combining the textual representations for forming a full textual representation of the number if the number has more than one digit, and otherwise forming the full textual representation of the number using the textual representation of the single digit; and converting the full textual representation of the number into speech.

According to another aspect of the invention, there is provided a device for converting a cardinal number of a decimal number system including at least one digit in a sequence of places ordered by powers of ten into a textual representation of a desired language, the device comprising: a converter configured to convert, one by one, each digit of the cardinal number into a textual representation of a desired language; a combiner configured to add a textual representation of a place value to a textual representation of a digit depending on a place of a digit in the sequence of places ordered by powers of ten; and a corrector configured to correct, on the basis of language-dependent rules defining correct expressions, any formed textual representation relating to at least one digit in a place known to result in a textual representation differing from a correct expression.

According to another aspect of the invention, there is provided a device for converting a cardinal number of a decimal number system including at least one digit in a sequence of places ordered by powers of ten into a textual representation of a desired language, the device comprising: means for converting, one by one, each digit of the cardinal number into a textual representation of a desired language; means for adding a textual representation of a place value to a textual representation of a digit depending on a place of a digit in the sequence of places ordered by powers of ten; and means for correcting, on the basis of language-dependent rules defining correct expressions, any formed textual representation relating to at least one digit in a place known to result in a textual representation differing from a correct expression.

According to another aspect of the invention, there is provided a device for converting a cardinal number of a decimal number system including at least one digit in a sequence of places ordered by powers of ten into speech of a desired language, the device comprising: a converter configured, one by one, to convert each digit of the cardinal number into a textual representation of a desired language; a combiner configured to add a textual representation of a place value to a textual representation of a digit depending on a place of a digit in the sequence of places ordered by powers of ten; a corrector configured to correct, on the basis of language-dependent rules defining correct expressions, any formed textual representation relating to at least one digit in a place known to result in a textual representation differing from a correct expression, and to combine the textual representations for forming a full textual representation of the number if the number has more than one digit, and otherwise to form the full textual representation of the number using the textual representation of the single digit; and a synthesizer configured to convert the full textual representation of the number into speech.

According to another aspect of the invention, there is provided a device for converting a cardinal number of a decimal number system including at least one digit in a sequence of places ordered by powers of ten into speech of a desired language, the device comprising: means for converting, one by one, each digit of the cardinal number into a textual representation of a desired language; means for adding a textual representation of a place value to a textual representation of a digit depending on a place of a digit in the sequence of places ordered by powers of ten; means for correcting, on the basis of language-dependent rules defining correct expressions, any formed textual representation relating to at least one digit in a place known to result in a textual representation differing from a correct expression, and combining the textual representations for forming a full textual representation of the number if the number has more than one digit, and otherwise to form the full textual representation of the number using the textual representation of the single digit; and means for converting the full textual representation of the number into speech.

According to another aspect of the invention, there is provided a subscriber terminal including a device for converting a cardinal number of a decimal number system including at least one digit in a sequence of places ordered by powers of ten into a textual representation of a desired language, the device comprising: a converter configured, one by one, to convert each digit of the cardinal number into a textual representation of a desired language; a combiner configured to add a textual representation of a place value to a textual representation of a digit depending on a place of a digit in the sequence of places ordered by powers of ten; and a corrector configured to correct, on the basis of language-dependent rules defining correct expressions, any formed textual representation relating to at least one digit in a place known to result in a textual representation differing from a correct expression.

According to another aspect of the invention, there is provided a subscriber terminal including a device for converting a cardinal number of a decimal number system including at least one digit in a sequence of places ordered by powers of ten into a textual representation of a desired language, the device comprising: means for converting, one by one, each digit of the cardinal number into a textual representation of a desired language; means for adding a textual representation of a place value to a textual representation of a digit depending on a place of a digit in the sequence of places ordered by powers of ten; and means for correcting, on the basis of language-dependent rules defining correct expressions, any formed textual representation relating to at least one digit in a place known to result in a textual representation differing from a correct expression.

According to another aspect of the invention, there is provided a subscriber terminal including a device for converting a cardinal number of a decimal number system including at least one digit in a sequence of places ordered by powers of ten into speech of a desired language, the device comprising: a converter configured to convert, one by one, each digit of the cardinal number into a textual representation of a desired language; a combiner configured to add a textual representation of a place value to a textual representation of a digit depending on a place of a digit in the sequence of places ordered by powers of ten; a corrector configured to correct, on the basis of language-dependent rules defining correct expressions, any formed textual representation relating to at least one digit in a place known to result in a textual representation differing from a correct expression, and to combine the textual representations for forming a full textual representation of the number if the number has more than one digit, and otherwise to form the full textual representation of the number using the textual representation of the single digit; and a synthesizer configured to convert the full textual representation of the number into speech.

According to another aspect of the invention, there is provided a subscriber terminal including a device for converting a cardinal number of a decimal number system including at least one digit in a sequence of places ordered by powers of ten into speech of a desired language, the device comprising: means for converting, one by one, each digit of the cardinal number into a textual representation of a desired language; means for adding a textual representation of a place value to a textual representation of a digit depending on a place of a digit in the sequence of places ordered by powers of ten; means for correcting, on the basis of language-dependent rules defining correct expressions, any formed textual representation relating to at least one digit in a place known to result in a textual representation differing from a correct expression, and combining the textual representations for forming a full textual representation of the number if the number has more than one digit, and otherwise to form the full textual representation of the number using the textual representation of the single digit; and means for converting the full textual representation of the number into speech.

According to another aspect of the invention, there is provided a computer program product encoding a computer program of instructions for executing a computer process for converting a cardinal number of a decimal number system including at least one digit in a sequence of places ordered by powers of ten into a textual representation of a desired language, the process comprising: converting, one by one, each digit of the cardinal number into a textual representation of a desired language; performing the following operation depending on a place of a digit in the sequence of places ordered by powers of ten: adding a textual representation of a place value to a textual representation of a digit; and performing additionally the following operation on the basis of language-dependent rules defining correct expressions: correcting any formed textual representation relating to at least one digit in a place known to result in a textual representation differing from a correct expression.

According to another aspect of the invention, there is provided a computer program product encoding a computer program of instructions for executing a computer process for converting a cardinal number of a decimal number system including at least one digit in a sequence of places ordered by powers of ten into speech of a desired language, the process comprising: converting, one by one, each digit of the cardinal number into a textual representation of a desired language; performing the following operation depending on a place of a digit in the sequence of places ordered by powers of ten: adding a textual representation of a place value to a textual representation of a digit; performing additionally the following operation on the basis of language-dependent rules defining correct expressions: correcting any formed textual representation relating to at least one digit in a place known to result in a textual representation differing from a correct expression; combining the textual representations for forming a full textual representation of the number if the number has more than one digit, and otherwise forming the full textual representation of the number using the textual representation of the single digit; and converting the full textual representation of the number into speech.

According to another aspect of the invention, there is provided a computer program distribution medium readable by a computer and encoding a computer program of instructions for executing a computer process for converting a cardinal number of a decimal number system including at least one digit in a sequence of places ordered by powers of ten into a textual representation of a desired language, the process comprising: converting, one by one, each digit of the cardinal number into a textual representation of a desired language; performing the following operation depending on a place of a digit in the sequence of places ordered by powers of ten: adding a textual representation of a place value to a textual representation of a digit; and performing additionally the following operation on the basis of language-dependent rules defining correct expressions: correcting any formed textual representation relating to at least one digit in a place known to result in a textual representation differing from a correct expression.

According to another aspect of the invention, there is provided a computer program distribution medium readable by a computer and encoding a computer program of instructions for executing a computer process for converting a cardinal number of a decimal number system including at least one digit in a sequence of places ordered by powers of ten into speech of a desired language, the process comprising: converting, one by one, each digit of the cardinal number into a textual representation of a desired language; performing the following operation depending on a place of a digit in the sequence of places ordered by powers of ten: adding a textual representation of a place value to a textual representation of a digit; performing additionally the following operation on the basis of language-dependent rules defining correct expressions: correcting any formed textual representation relating to at least one digit in a place known to result in a textual representation differing from a correct expression; combining the textual representations for forming a full textual representation of the number if the number has more than one digit, and otherwise forming the full textual representation of the number using the textual representation of the single digit; and converting the full textual representation of the number into speech.

According to another aspect of the invention, there is provided a data structure for converting a cardinal number of a decimal number system including at least one digit in a sequence of places ordered by powers of ten into a textual representation of a desired language, the data structure comprising: a first data field including information for converting, one by one, each digit of the cardinal number into a textual representation of a desired language; a second data field including information for adding a textual representation of a place value to a textual representation of a digit depending on a place of a digit in the sequence of places ordered by powers of ten; and a third data field including information for correcting any formed textual representation relating to at least one digit in a place known to result in a textual representation differing from a correct expression on the basis of language-dependent rules defining correct expressions.

According to another aspect of the invention, there is provided a computer program distribution medium readable by a computer, the computer program distribution medium having data structure for converting a cardinal number of a decimal number system including at least one digit in a sequence of places ordered by powers of ten into a textual representation of a desired language, the data structure comprising: a first data field including information for converting, one by one, each digit of the cardinal number into a textual representation of a desired language; a second data field including information for adding a textual representation of a place value to a textual representation of a digit depending on a place of a digit in the sequence of places ordered by powers of ten; and a third data field including information for correcting any formed textual representation relating to at least one digit in a place known to result in a textual representation differing from a correct expression on the basis of language-dependent rules defining correct expressions.

According to another aspect of the invention, there is provided a data structure for converting a cardinal number of a decimal number system including at least one digit in a sequence of places ordered by powers of ten into speech of a desired language, the data structure comprising: a first data field including information for converting, one by one, each digit of the cardinal number into a textual representation of a desired language; a second data field including information for adding a textual representation of a place value to a textual representation of a digit depending on a place of a digit in the sequence of places ordered by powers of ten; a third data field including information for correcting any formed textual representation relating to at least one digit in a place known to result in a textual representation differing from a correct expression on the basis of language-dependent rules defining correct expressions, for combining the textual representations for forming a full textual representation of the number if the number has more than one digit, and otherwise forming the full textual representation of the number using the textual representation of the single digit, and for converting the full textual representation of the number into speech.

According to another aspect of the invention, there is provided a computer program distribution medium readable by a computer, the computer program distribution medium having data structure for converting a cardinal number of a decimal number system including at least one digit in a sequence of places ordered by powers of ten into speech of a desired language, the data structure comprising: a first data field including information for converting, one by one, each digit of the cardinal number into a textual representation of a desired language; a second data field including information for adding a textual representation of a place value to a textual representation of a digit depending on a place of a digit in the sequence of places ordered by powers of ten; a third data field including information for correcting any formed textual representation relating to at least one digit in a place known to result in a textual representation differing from a correct expression on the basis of language-dependent rules defining correct expressions, for combining the textual representations for forming a full textual representation of the number if the number has more than one digit, and otherwise forming the full textual representation of the number using the textual representation of the single digit, and for converting the full textual representation of the number into speech.

The invention provides several advantages. The present solution provides a simple and effective way to convert a number into text and speech. The solution is very memory efficient and allows good coverage of numeric values with a very low memory footprint. A set of rules can be represented as data which can be included in language specific packages. This and uncomplicated syntax simplify logistics in manufacturing product variants in various languages.

### LIST OF DRAWINGS

In the following, the invention will be described in greater detail with reference to the embodiments and the accompanying drawings, in which

FIG. 1 shows a block diagram of a text-to-speech system;

FIG. 2 illustrates terminal equipment of a radio system;

FIG. 3 illustrates a normalization operation block;

FIG. 4 illustrates conversion of a number into written English;

FIG. 5 shows a table for converting numbers smaller than ten into written English;

FIG. 6 shows a table of place values in written English;

FIG. 7A shows a first part of a correction table of textual representations in English;

FIG. 7B shows a second part of a correction table of textual representations in English;

FIG. 8A illustrates conversion of digits into written Finnish;

FIG. 8B illustrates a table of place values in written Finnish;

FIG. 8C illustrates a correction table of textual representations in Finnish.

FIG. 9A illustrates conversion of digits into written Swedish;

FIG. 9B illustrates a table of place values in written Swedish;

FIG. 9C illustrates a first part of a correction table of textual representations in Swedish;

FIG. 9D illustrates a second part of a correction table of textual representations in Swedish;

FIG. 10A illustrates conversion of digits into written French;

FIG. 10B illustrates a table of place values in written French;

FIG. 10C illustrates a first part of a correction table of textual representations in French;

FIG. 10D illustrates a second part of a correction table of textual representations in French;

FIG. 10E illustrates a third part of a correction table of textual representations in French;

FIG. 11A illustrates conversion of digits into written German;

FIG. 11B illustrates a table of place values in written German;

FIG. 11C illustrates a first part of a correction table of textual representations in German;

FIG. 11D illustrates a second part of a correction table of textual representations in German;

FIG. 12A illustrates conversion of digits into written Danish;

FIG. 12B illustrates a table of place values in written Danish;

FIG. 12C illustrates a first part of a correction table of textual representations in Danish;

FIG. 12D illustrates a second part of a correction table of textual representations in Danish;

FIG. 13A illustrates conversion of digits into written Hungarian;

FIG. 13B illustrates a table of place values in written Hungarian;

FIG. 13C illustrates a first part of a correction table of textual representations in Hungarian;

FIG. 13D illustrates a second part of a correction table of textual representations in Hungarian;

FIG. 14A illustrates conversion of digits into written Italian;

FIG. 14B illustrates a table of place values in written Italian;

FIG. 14C illustrates a first part of a correction table of textual representations in Italian;

FIG. 14D illustrates a second part of a correction table of textual representations in Italian;

FIG. 15A illustrates conversion of digits into written Mandarin Chinese;

FIG. 15B illustrates a table of place values in written Mandarin Chinese;

FIG. 15C illustrates a correction table of textual representations in Mandarin Chinese;

FIG. 16A illustrates conversion of digits into written Ukrainian;

FIG. 16B illustrates a table of place values in written Ukrainian;

FIG. 16C illustrates a first part of a correction table of textual representations in Ukrainian;

FIG. 16D illustrates a second part of a correction table of textual representations in Ukrainian;

FIG. 16E illustrates a third part of a correction table of textual representations in Ukrainian;

FIG. 17 shows a flow chart of conversion into text;

FIG. 18 shows a flow chart of conversion into speech;

FIG. 19 shows a register set-up for converting time;

FIG. 20A shows register elements after a first step of conversion;

FIG. 20B shows the register elements after a second step of conversion; and

FIG. 21 shows a register set-up for converting abbreviations; and

FIG. 22 shows register elements after conversion.

### DESCRIPTION OF EMBODIMENTS

The present solution is suitable for electronic devices which may be user equipment, a computer etc. Application fields may include message reading, user interface for handsfree or eyesfree devices, automated context aware announcement systems and aids for the visually impaired.

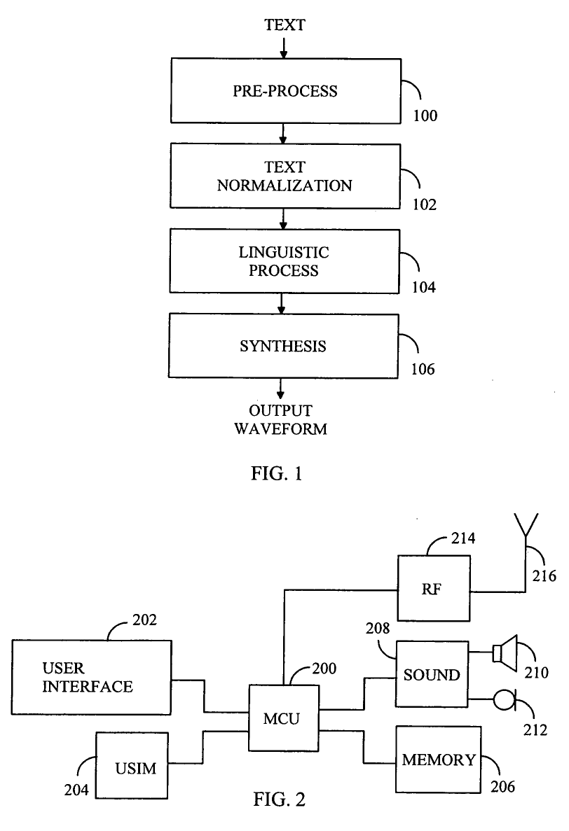

With reference to FIG. 1, examine a block diagram of a text-to-speech (TTS) system. Text including written characters, numbers, special markers and/or annotations can be fed to a pre-processing operation block 100. Pre-processing may include parsing which, in turn, may include interpreting the special markers and annotations in the text to control the synthesis process, for example, definition of paragraphs, specific stressing of a certain word, etc. The pre-processing may also include some application specific processing, such as removing unnecessary information from the text. The unnecessary information may be e.g. a header (of an e-mail) or unpronounceable characters such as “*******”

After pre-processing the text can be normalized in a normalization operation block 102. This block 102 may include, for example, converting numbers into textual representations, expanding abbreviations etc. A rule-based method for creating a text string of a number for pronunciation can be used. In the prior art, the rules for creating text strings of numbers are usually coded within a language specific program code, for instance, DLL (Dynamically Loaded Library). In some systems a complex script language that also handles other language specific processing is provided.

A linguistic processing block 104 may include linguistic and syntactic analysis and prosodic analysis. The linguistic and syntactic analysis may include morphological analysis, contextual analysis and categorizing words into clauses on the basis of some criteria. The prosodic analysis may utilize the linguistic and syntactic analysis to assign, for example, intonation contours, pauses, stress and speech segment durations.

A synthesis block 106 may perform letter-to-sound or text-to-phoneme conversion on the basis of data received from the linguistic processing block 104 in order to generate the actual speech waveform.

FIG. 2 is now used to study terminal equipment of a radio system as an example of an electronic device which may utilize the present solution. The terminal equipment may comprise mobile equipment (blocks 200, 202, 206 to 216) as an operational unit and a USIM (Universal mobile telephone system Subscriber Identity Module) module or a SIM as a user-specific module 204. The user-specific module is a smart card which comprises a microprocessor and memory. Operational unit data, personal data of the user and identification data of the user interface can be stored in the memory of the USIM module.

The terminal equipment comprises a processor 200, in which a computer program operations of the terminal equipment may be performed. For instance, the processor 200 may take care of digital signal treatment and controls the operation of other blocks. The user controls the electronic device and enters data with the terminal equipment's user interface 202 (display and keypad), and visual information, such as text and images, treated by the processor 200 is displayed to the user with the user interface. Data required by the processor 200 can be stored in a memory 206. A sound-processing unit 208 converts a signal arriving from the processor 200 to suit a loudspeaker 210. The sound-processing unit 208 may be a synthesizer for synthesing speech form text. Additionally, the speech-processing unit 208 may include a codec block. The sound-processing unit 208 may also convert a signal arriving from a microphone 212 to suit the processor 200. An RF block 214, in turn, converts a digital signal to be transmitted and arriving from the processor 200 into an analog, radio-frequency signal, so that the signal can be transmitted as electromagnetic radiation via an antenna 216. Correspondingly, a radio-frequency signal received by the antenna 216 is converted to a lower frequency and is digitized in the RF block 214 prior to application to the processor 200.

The present solution concentrates on the normalization operation block 102 where conversion of numbers into textual representations can be performed. Cardinal numbers 0, 1, 2, 3, . . . , which can be referred to as finite cardinal numbers, can also be called counting numbers, natural numbers, non-negative integers or whole numbers. They include no decimal part nor a fractional part. A cardinal number of a decimal number system includes at least one digit in a sequence of places ordered by powers of ten. For example, the number 15243 is a sequence of 1, 5, 2, 4 and 3 and it can be interpreted such that the number “1” represents how many times 10 000=10⁴ is included in the number. The number “5” represents how many times 1000=10³ is included in the number. The number “2” represents how many times 100=10² is included in the number. The number “4” represents how many times 10=10¹ is included in the number. Finally, the number “3” represents how many times 1=10⁰ is included in the number. The numbers 10 000=10⁴, 1000=10³, 100=10², 10=10¹ and 1=10⁰ are powers of ten, and the powers of ten define the place of the digit (in this example the places of 1, 2, 3, 4 and 5) in the sequence.

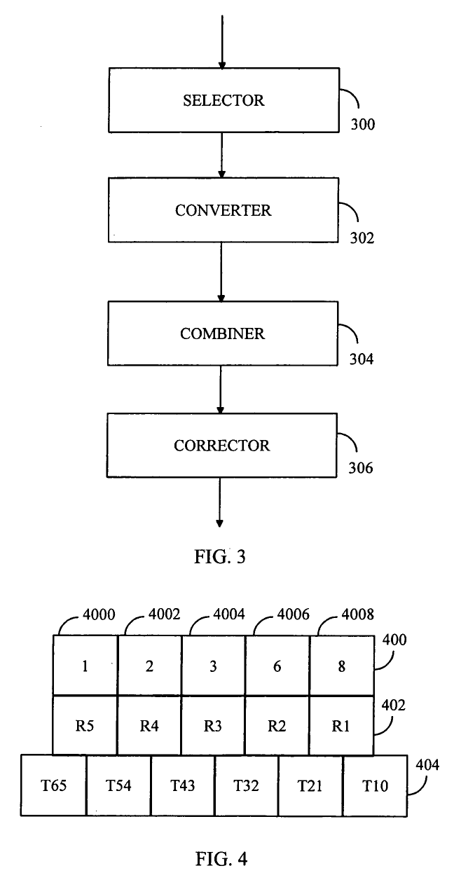

FIG. 3 illustrates the normalization operation block 102 which may perform the conversion of a number into textual representation in the following manner. If a plurality of languages is available, a desired language should first be selected by a selector 300. The previous process 100 may select the language automatically by recognizing the language from the input words, or the user may define the language. The normalization operation block 102 also includes a converter 302, a combiner 304 and a corrector 306. The converter 302 converts each digit of the cardinal number one by one into a textual representation of a desired language.

The combiner 304 may add a textual representation of a place value to a textual representation of a digit. Whether or not the combiner adds the textual representation of a place value, may depend on a place of a digit in the sequence of places ordered by powers of ten. In the decimal number system, the value of a digit depends on its place, or position, in the number i.e. in the sequence of digits. Each place has a value of 10 times the place of the preceding place on the right. The place values are the values of the powers of ten and can be written as ones (1=10⁰), tens (10=10¹), hundreds (100=10²), thousands (1000=10³), ten thousands (10 000=10⁴), hundred thousands (100 000=10⁵), millions (1 000 000=10⁶), etc. When a place has zero, it means that the place has no value. For example, in the case of 1 000 000 the sixth place means zero times hundred thousands. But the seventh place means one times million. Hence, the result is “one million”. If the number is, for example, 2, the combiner 304 needs to add nothing when converting it into English, because the converter 302 provides the correct result “two”.

The corrector 306 may correct any textual representation formed by the converter 302 and the combiner 304. In many cases, the corrector 306 needs to correct nothing, since the textual representation formed by the converter 302 and/or combiner 304 is already correct. But as there are usually exceptions and irregularities in the natural languages, the corrector 306 is important. A natural language is a human language used by people when discussing together or writing to each other. A natural language has evolved naturally in the human society. For example, Finnish, English, French and Japanese are natural languages. A language, such as Esperanto, which has been artificially constructed by a person, may also be acceptable. All the textual representations formed by the converter 302 and the combiner 304 which differ from textual representations of the natural language can be known beforehand. Because their number is limited, the differences can easily be tabulated relating to a digit or a combination of digits in a place known to result in a textual representation differing from a correct expression. The correction may be based on language-dependent rules defining correct expressions. The language-dependent rules can be supported by grammatical rules of the desired language.

FIG. 4 illustrates an example using registers for conversion of a number into written English. The sequence of places ordered by powers of ten can be implemented as a sequence of register elements in a register. In a similar manner, the place values can be treated by a register having a row of register elements. A first register 400 includes the number to be converted into a textual representation. A second register 402 includes textual representations of the digits of the number in the desired language. A third register 404 includes textual representations of place values in the desired language. In this example the number is 12 368. The digit “1”, which is the most significant digit, is in a register element 4000 (which is for ten thousands), the digit “2” is in a register element 4002 (which is for thousands), the digit 3 is in a register element 4004 (which is for hundreds), the digit 6 is in a register element 4006 (which is for tens) and the digit 8, which is the least significant digit, is in the register element 4008 (which is for ones).

Applying a first rule according to which each digit of the cardinal number is converted, one by one, into a textual representation of a desired language, a register element R5 of the register 402 includes a textual representation “one”. In a similar manner, a register element R4 includes a textual representation “two”, a register element R3 includes a textual representation “three”, a register element R2 includes a textual representation “six”, and the register element R1 includes a textual representation “eight”. If, for example, the least significant digit were “0”, a textual representation in the register element R1 could have been “”, but it could have been “zero” as well.

When a second rule is applied, textual representations of place values are added to textual representations of digits. The textual representations are added depending on places of digits in the sequence of places ordered by powers of ten. According to this example the textual representation of the place value in a register element T65 is unnecessary because it refers to hundred thousands. The most significant digit (in this case “1”) can be searched for to determine a need for possible place values. The place value of “ten thousand” is actually unnecessary in English. Hence, the contents of a register element T54 is empty, i.e. register element T54=“”. Next, the place value of “thousand” in a register element T43 may be added to “2”. The place value of “hundred” in a register element T32 may be added to “3”. The place values of “ten” and “one” in register elements T21 and T10 are unnecessary in English. Hence, the contents of the register elements T21 and T10 are empty, i.e. register element T21=“” and register element T10=“”. Combining the textual representations results in R5 T54 R4 T43 R3 T32 R2 T21 R1 T10 in a textual form “one two thousand three hundred six eight”. The textual representation of the number becomes correct with the third rule, according to which any formed textual representation relating to at least one digit in a place known to result in a textual representation differing from a correct expression is corrected. In this example two differences from the correct expression exists: “one two” and “six”. But before examining the third rule to correct them, let us first study tabulated rules for converting the digit into a textual representation and for combining a place value with the digits.

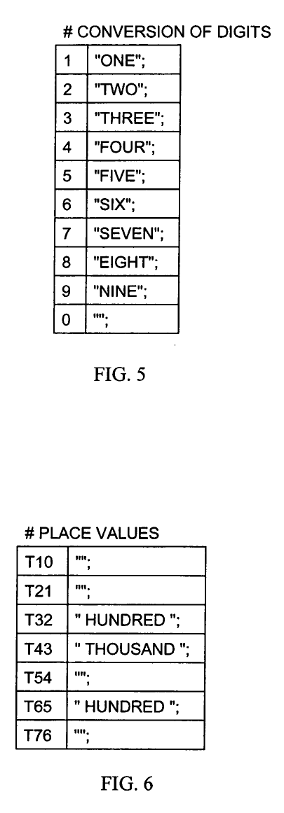

Next, data structure for converting a cardinal number is illustrated using FIGS. 5 to 16E. The data structure may be included in a computer program distribution medium readable by a computer. The language-specific data fields i.e. rules may be stored separately from the actual computer program performing the conversion. This enables the use of the same computer program for a plurality of languages, each language utilizing its own data fields during conversion.

FIG. 5 shows a first data field for converting numbers smaller than ten to textual representations in English. The first data field can be presented in a tabulated form. The table is straightforward and converts the number “1” to a textual representation “one”, number “2” to “two”, and so on. As a special case, the number “0” can be converted to “”, which means that zero may have an empty textual representation.

FIG. 6 shows a second data field for textual representations of place values in English. The second data field can also be presented in a tabulated form. The table in FIG. 6 refers to numbers smaller than one million. The necessary place values are for the register element T32=“hundred”, for the register element T43=“thousand” and for the register element T65=“hundred”. All other registers may be empty. A textual representation of a place value may be added to a textual representation of a digit according to the language-dependent rules defining correct expressions. The textual representation of a place value can be added behind a textual representation of a digit.

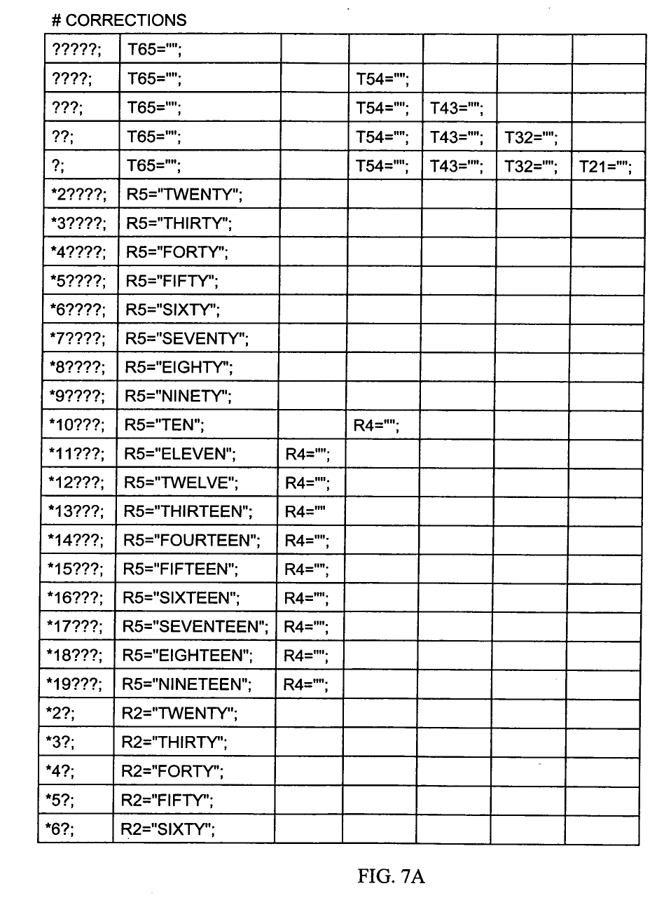

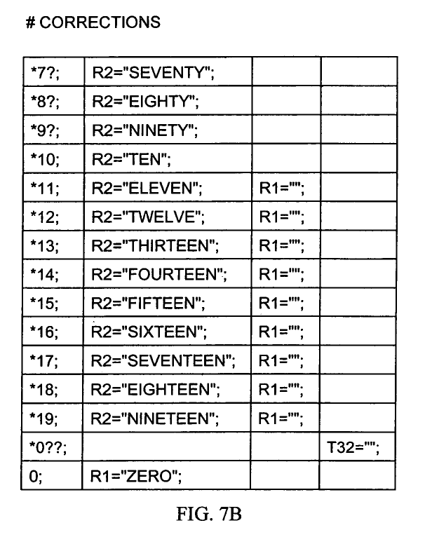

Let us now study a third data field for correcting textual representations. The third data field can also be presented in a tabulated form. The first part of the table is shown in FIG. 7A and a second part is shown in FIG. 7B. The three data fields can also be considered as rules. The third rule overrides the previous rules, and it is known beforehand where the two rules do not result in a correct expression in the desired language. Reasons for an incorrect expression can be, for example, inflection, order of numbers, gender, etc. However, irrespective of the reason, the textual representation can be corrected.

The number of question marks refers to the number of digits in the number while the asterisk refers to a wildcard character. Depending on the number of digits in the number, registers of place values are emptied. If the maximum number of digits is five in the number (i.e. the number is smaller than 100 000), the register elements TXX having an index XX larger than 54 are emptied. If the maximum number of digits is four in the number (i.e. the number is smaller than 10 000), the register elements TXX (such as T65 and T54) having the index XX larger than 43 are emptied. If the maximum number of digits is three in the number (i.e. the number is smaller than 1000), the register elements TXX having the index XX larger than 32 are emptied. If the maximum number of digits is two in the number (i.e. the number is less than 100), the register elements TXX having the index XX larger than 21 are emptied. If the maximum number of digits is one in the number (i.e. the number is less than 10), the register element T21 is emptied in the similar manner.

A correction in English may relate to ten thousands. If the fifth digit is “2”, the contents of the register element R5 is set to “twenty”. If the fifth digit is “3”, the contents of the register element R5 is set to “thirty”. If the fifth digit is “4”, the contents of the register element R5 is set to “forty”. If the fifth digit is “5”, the contents of the register element R5 is set to “fifty”. If the fifth digit is “6”, the contents of the register element R5 is set to “sixty”. If the fifth digit is “7”, the contents of the register element R5 is set to “seventy”. If the fifth digit is “8”, the contents of the register element R5 is set to “eighty”. If the fifth digit is “9”, the contents of the register element R5 is set to “ninety”.

A correction in English may relate to numbers from ten thousand to nineteen thousand. In all of these cases, the fifth digit is “1” and the contents of the register element R4 is set to be empty. If the fourth digit is “0”, the contents of the register element R5 is “ten”. If the fourth digit is “1”, the contents of the register element R5 is set to “eleven”. If the fourth digit is “2”, the contents of the register element R5 is set to “twelve”. If the fourth digit is “3”, the contents of the register element R5 is set to “thirteen”. If the fourth digit is “4”, the contents of the register element R5 is set to “fourteen”. If the fourth digit is “5”, the contents of the register element R5 is set to “fifteen”. If the fourth digit is “6”, the contents of the register element R5 is set to “sixteen”. If the fourth digit is “7”, the contents of the register element R5 is set to “seventeen”. If the fourth digit is “8”, the contents of the register element R5 is set to “eighteen”. If the fourth digit is “9”, the contents of the register element R5 is set to “nineteen”.

In the cases relating to ten thousands and to the numbers from ten thousand to nineteen thousand, the textual representation of the combination of successive digits of a number including more than one digit in a place known to result in an incorrect expression is corrected. The correction can be performed by replacing the textual representation known to be incorrect by a correct textual representation.

A correction in English may relate to tens. If the second digit is “2”, the register element R2 is set to “twenty”. If the second digit is “3”, the register element R2 is set to “thirty”. If the second digit is “4”, the register element R2 is set to “forty”. If the second digit is “5”, the register element R2 is set to “fifty”. If the second digit is “6”, the register element R2 is set to “sixty”. If the second digit is “7”, the register element R2 is set to “seventy”. If the second digit is “8”, the register element R2 is set to “eighty”. If the second digit is “9”, the register element R2 is set to “ninety”.

A correction in English may relate to numbers between ten and twenty. In all these cases the second digit is “1”. If the first digit is “1”, the contents of the register element R2 is set to “eleven”. If the first digit is “2”, the contents of the register element R2 is set to “twelve”. If the first digit is “3”, the contents of the register element R2 is set to “thirteen”. If the first digit is “4”, the contents of the register element R2 is set to “fourteen”. If the first digit is “5”, the contents of the register element R2 is set to “fifteen”. If the first digit is “6”, the contents of the register element R2 is set to “sixteen”. If the first digit is “7”, the contents of the register element R2 is set to “seventeen”. If the first digit is “8”, the contents of the register element R2 is set to “eighteen”. If the first digit is “9”, the contents of the register element R2 is set to “nineteen”.

In the cases relating to tens and to the numbers between ten and twenty the textual representation of the combination of successive digits of a number including more than one digit in a place known to result in an incorrect expression is corrected. The correction can be performed by replacing the textual representation known to be incorrect by a correct textual representation.

If the third digit is “0”, the contents of the register element T32 is set to be empty. Finally, if the number is “0”, the contents of the register element R1 is set to “zero” while the other registers are emptied. After the necessary corrections, which in this case mean applying corrections relating to values between ten thousand and nineteen thousand (*12???→R5=“twelve”) and values between twenty and ninety (*6?→R2=“sixty”), the example of 12 368 becomes “twelve thousand three hundred sixty eight”. Before correction, the textual representation of *6? can be “six ten” or just “six”. Both forms can be corrected into the textual representation “sixty”.

This kind of method can be applied to a plurality of languages while the principles of applying place values and corrections differ from language to language. The different application of place values and corrections can be handled easily by changing the contents of register elements according to language-dependent rules defining correct expressions. The syntax is very simple and contains conditions and assignments only. Once again in short, each digit can be assigned as <number register element>=“<string>”. The place values can be formed as <place value register element >=“<string>”. The correction can be formed as <matching criteria>;<register element >=“<string>”|<register element >;<register element >=“<string>”|<register element>; . . . Matching criteria may use a wildcard character at the beginning or in the end of the criteria and an “any character” sign “?” at any location of the criteria. Otherwise < >denotes a required string, [ ] denotes an optional string, | is a separator between alternative, mutually exclusive arguments, ? is a symbol indicating any single digit, and * is a symbol indicating any number of digits.

Let us look at examples of the number “534 676” in English, Finnish, Swedish, French, German, Danish, Hungarian, Italian, Mandarin Chinese (Japanese) and Ukrainian. After applying the first rule, the number becomes five three four six seven six in English. After applying the second rule, the number becomes “” five hundred three “” four thousand six hundred seven six “”. After the third, rule the number can be written correctly by combining the textual representations together “” five hundred thirty”” four thousand six hundred seventy”” six””.

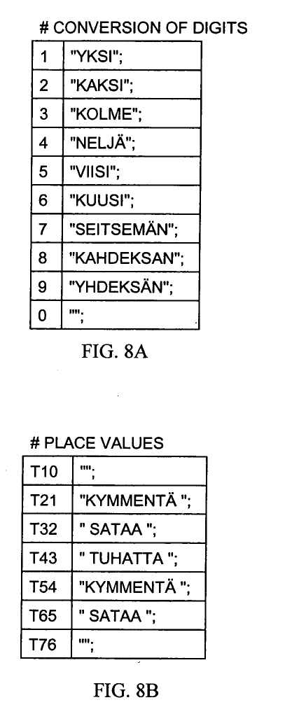

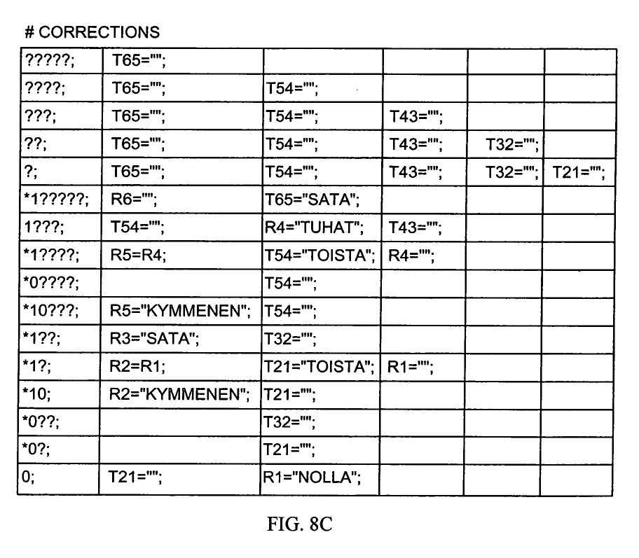

FIG. 8A illustrates conversion of digits into textual representations in Finnish. After this conversion, the number becomes “” viisi kolme neljä kuusi seitsemän kuusi.

FIG. 8B illustrates addition of place values in Finnish. After the addition, the number becomes “” viisi sataa kolme kymmentä neljä tuhatta kuusi sataa seitsemän kymmentä kuusi “”. It can be noticed that in Finnish, the textual representation of the number is practically correct after the first and the second rule.

FIG. 8C illustrates correction of the textual representations in Finnish. The correct form of the number is the combination of the textual representations“” viisi sataa kolmekymmentä neljä tuhatta kuusi sataa seitsemän kymmentä kuusi””. In Finnish, the place value for tens can be added using the second rule. In English, tens have to be corrected using the third rule.

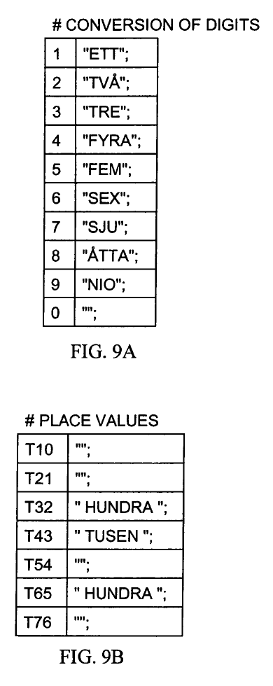

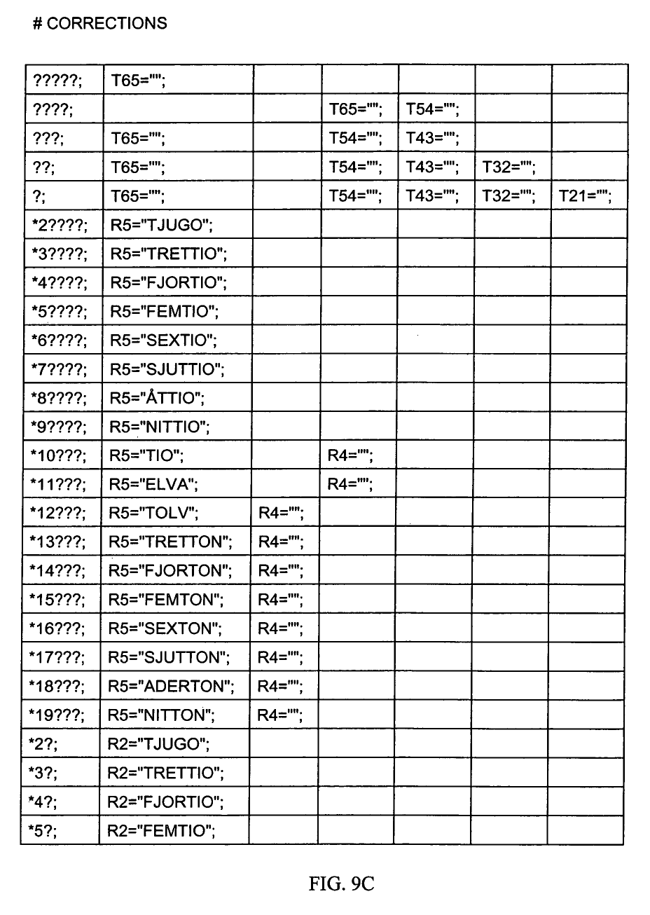

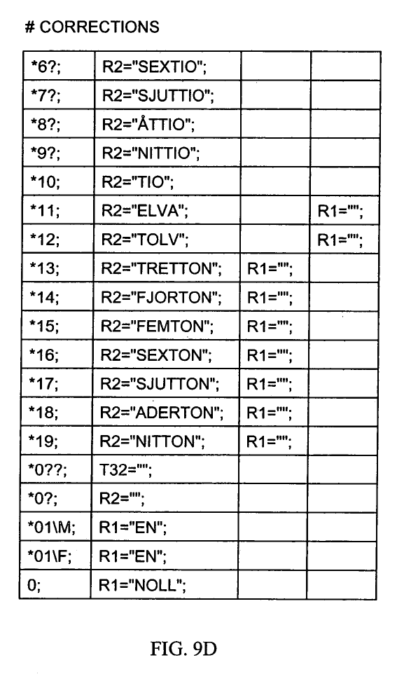

FIG. 9A illustrates conversion of digits into textual representations in Swedish. After this conversion, the number becomes “” fem tre fyra sex sju sex.

FIG. 9B illustrates the addition of place values in Swedish. After the addition the number becomes “” fem hundra tre “” fyra tusen sex hundra sju “” sex“”.

FIGS. 9C and 9D illustrate correction of the textual representations in Swedish. The correct form of the number is “” fem hundra trettio“” fyra tusen sex hundra sjuttio””sex””.

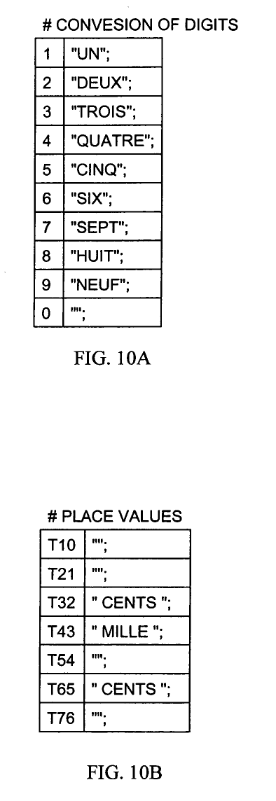

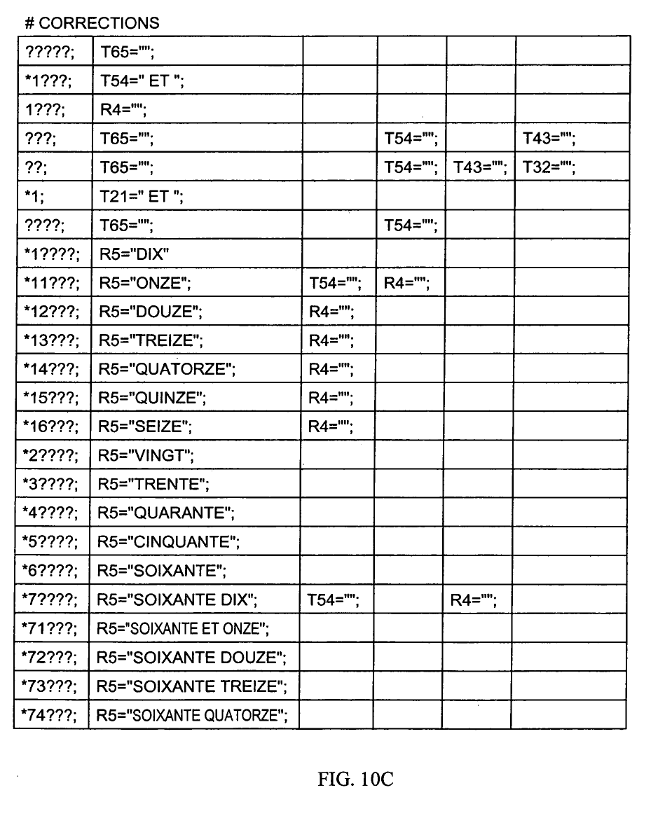

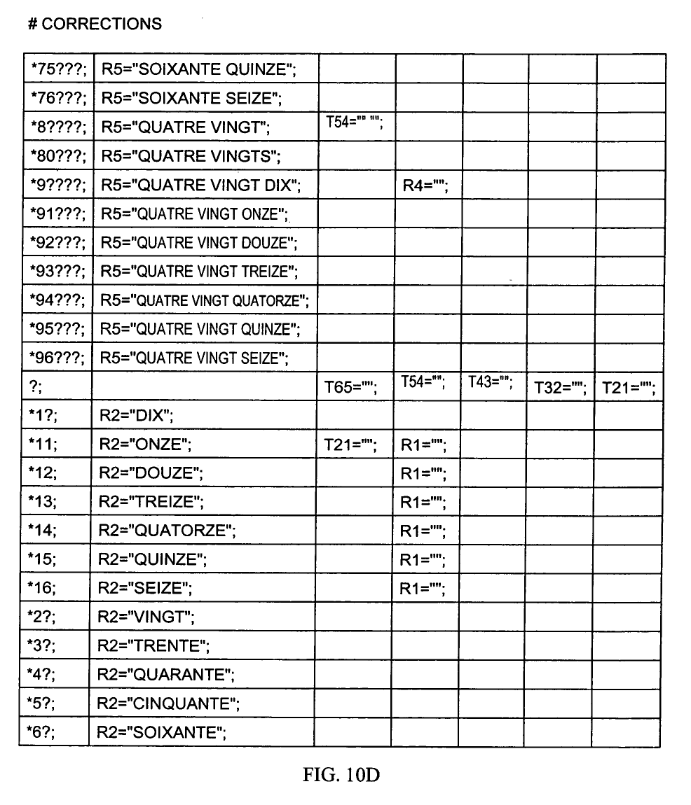

FIG. 10A illustrates conversion of digits into textual representations in French. After this conversion, the number becomes “” cinq trois quatre six sept six.

FIG. 10B illustrates addition of the place values in French. After the addition the number becomes “” cinq cents trois “” quatre mille six cents sept “” six “”.

FIGS. 10C, 10D and 10E illustrate correction of the textual representations in French. The correct form of the number is “” cinq cents trente””quatre mille six cents soixante seize”””””.

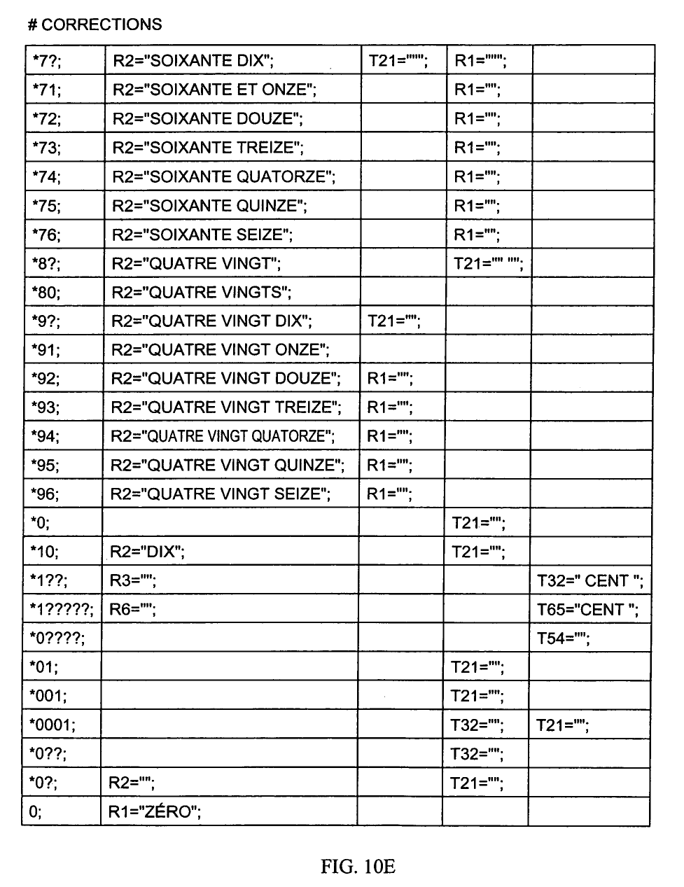

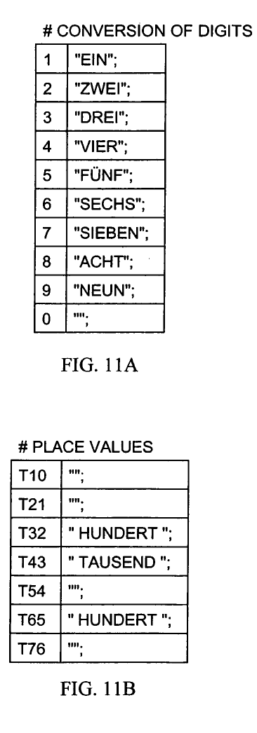

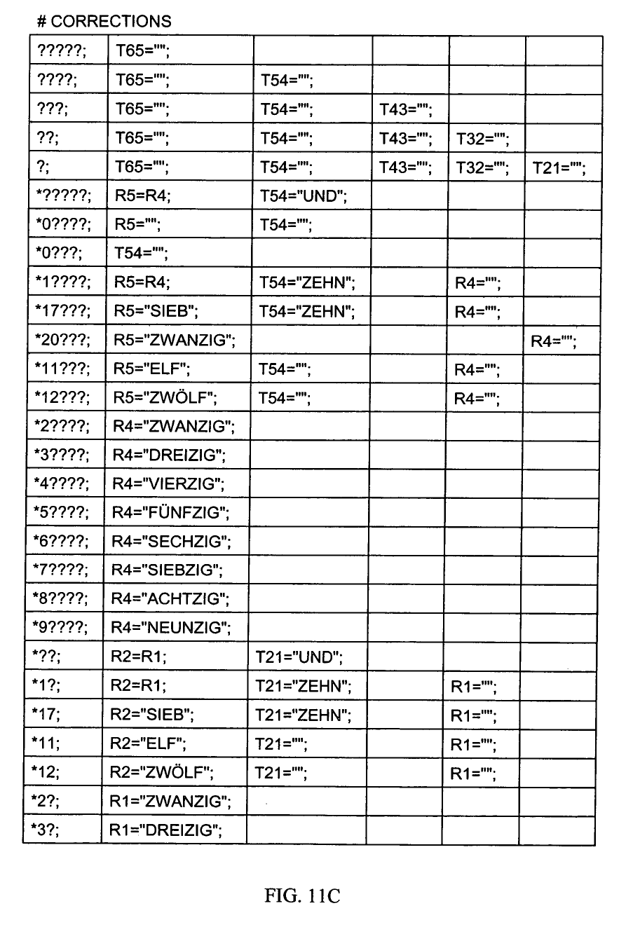

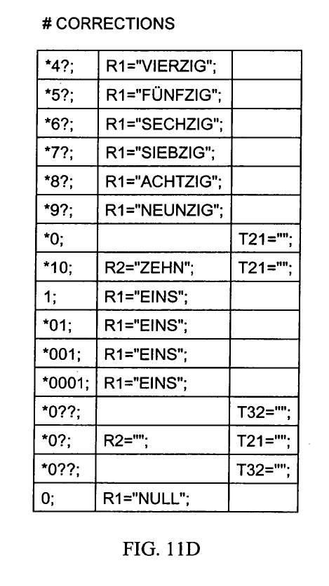

FIG. 11A illustrates conversion of digits into textual representations in German. After the conversion the number becomes “” fünf drei vier sechs sieben sechs“”.

FIG. 11B illustrates addition of place values in German. After the addition the number becomes “”fünf hundert drei “” vier tausend sechs hundert sieben “” sechs“”.

FIGS. 11C and 11D illustrate correction of the textual representations in German. The correct form of the number is “” fünf hundert vierunddreizig tausend sechs hundert sechsundsiebzig“”. In German, the speciality is the structure of tens being combined with ones.

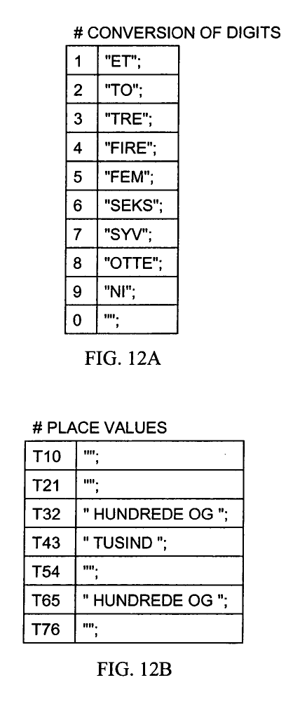

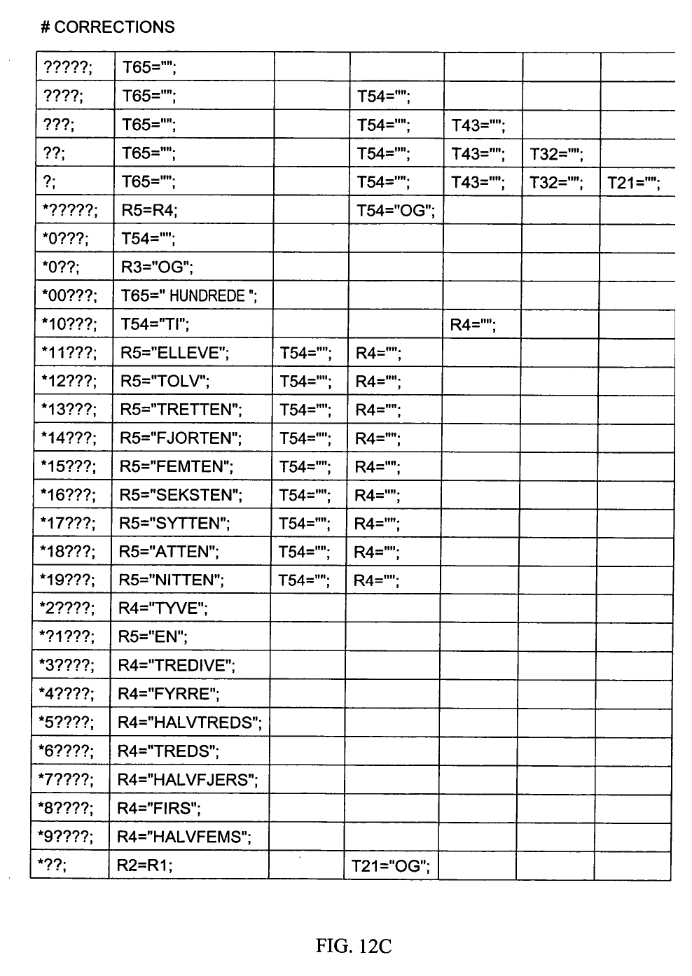

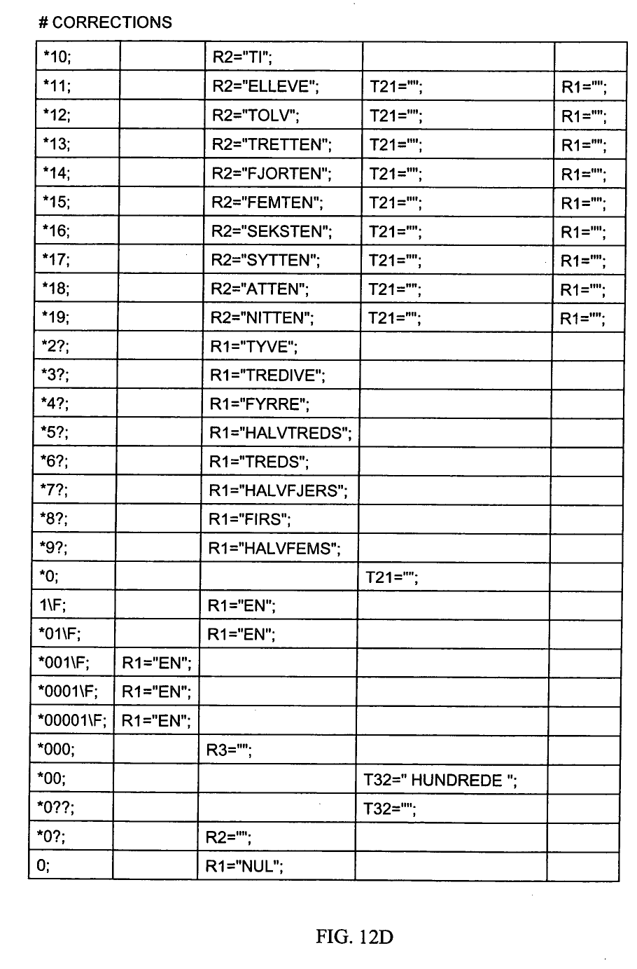

FIG. 12A illustrates conversion of digits into textual representations in Danish. After the conversion, the number becomes “” fem tre fire seks syv seks.

FIG. 12B illustrates addition of place values in Danish. After the addition, the number becomes “” fem hundrede og tre “” fire tusind seks hundrede og syv “” seks “”.

FIGS. 12C and 12D illustrate correction of the textual representations in Danish. The correct form of the number is “” fem hundrede og fireogtredive tusind seks hundrede og seksoghalvfjers””.

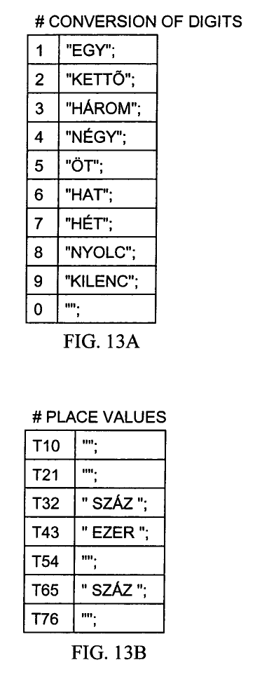

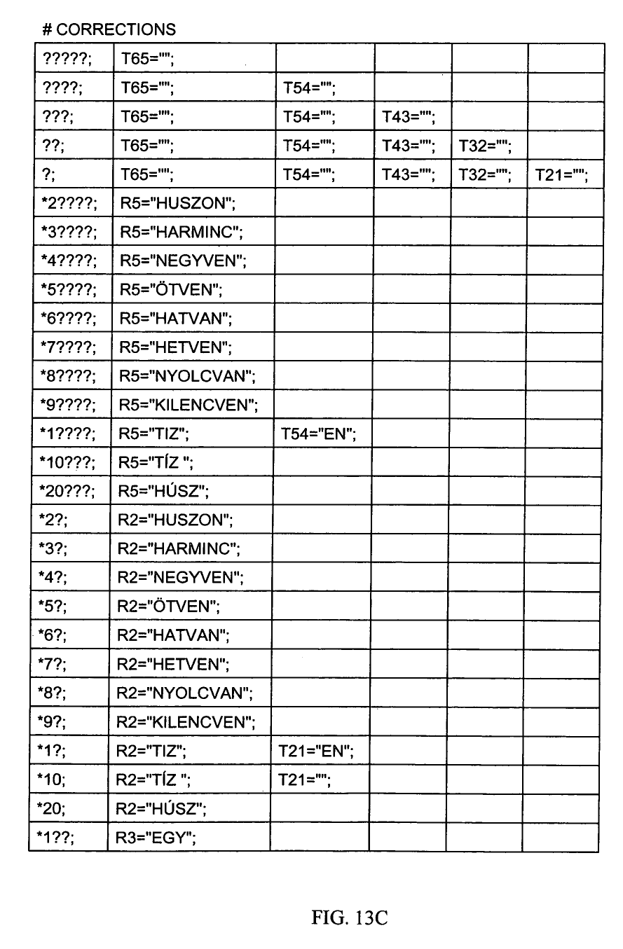

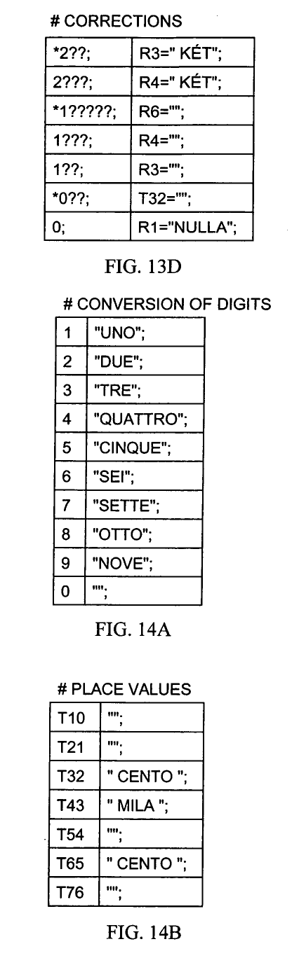

FIG. 13A illustrates conversion of digits into textual representations in Hungarian. After the conversion, the number becomes “”öt három négy hat hét hat.

FIG. 13B illustrates addition of place values in Hungarian. After the addition, the number becomes “” öt szäz három “” négy ezer hat száz hét“” hat“”.

FIGS. 13C and 13D illustrate correction of the textual representations in Hungarian. The correct form of the number is “” öt száz harminc”” négy ezer hat száz hetven””hat””.

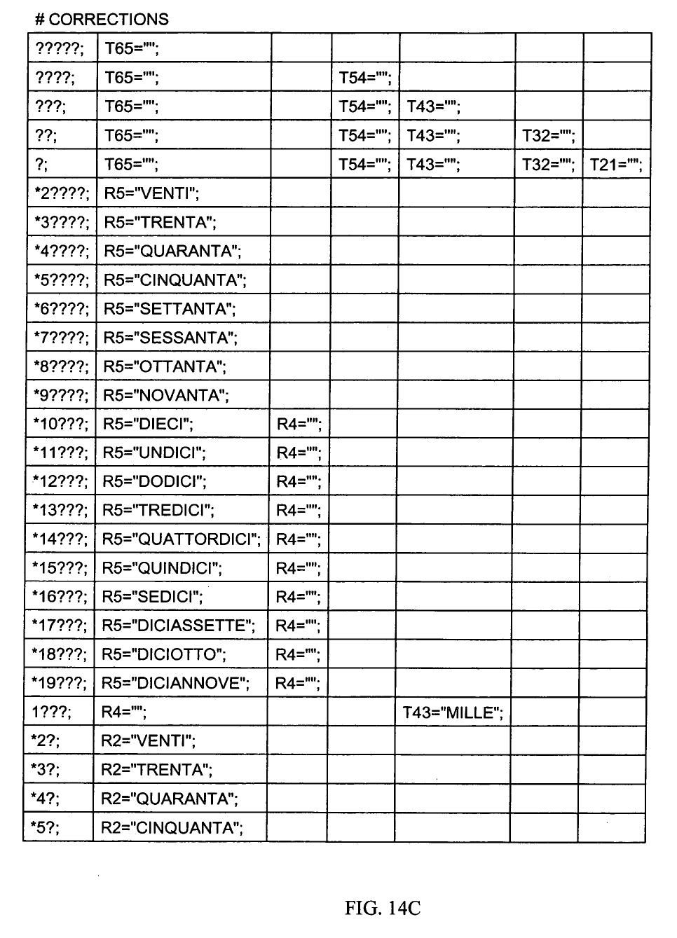

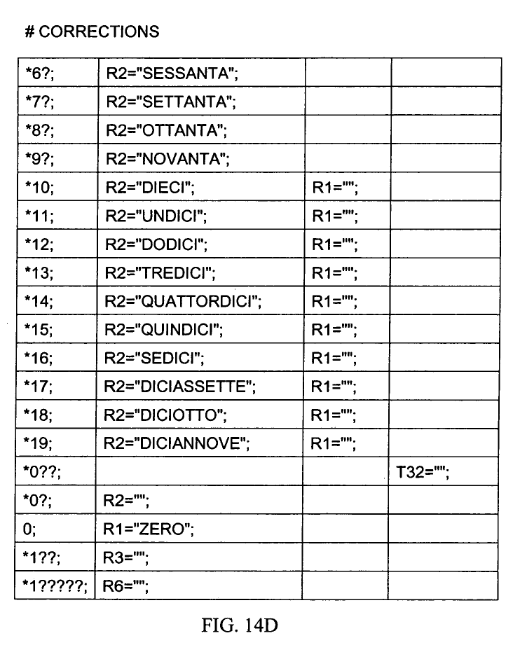

FIG. 14A illustrates conversion of digits into textual representations in Italian. After the conversion, the number becomes “” cinque tre quattro sei sette sei.

FIG. 14B illustrates addition of place values in Italian. After the addition, the number becomes “” cinque cento tre “” quattro mila sei cento sette “” sei“”.

FIGS. 14C and 14D illustrate correction of the textual representations in Italian. The correct form of the number is “” cinque cento trenta””quattro mila sei cento settanta””sei””.

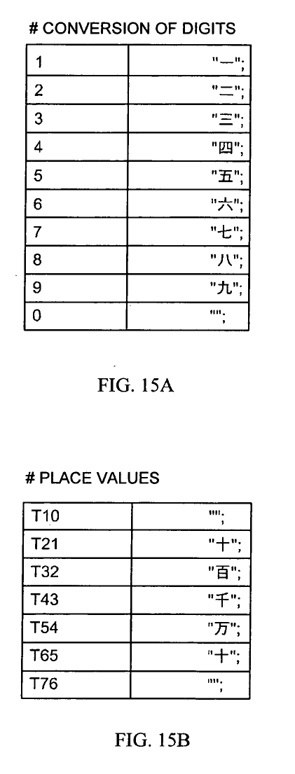

FIG. 15A illustrates conversion of digits into textual representations in Mandarin Chinese. After the conversion, the number becomes [symbol] FIG. 15B illustrates addition of place values in Mandarin Chinese. After the addition the number becomes

[symbol]

[symbol]

FIG. 15C illustrates correction of the textual representations in Mandarin Chinese. The correct form of the number is [symbol] [symbol] The conversion of the number into kanji characters is the same in Japanese, too. A speciality in this conversion is the place value [symbol] which represents 10 000. The next special place value is at 100 000 000, and so on. The Japanese pronunciation of the number [symbol] [symbol] can be written with alphabets as “go juu san man yon sen roppyaku nana juu roku”.

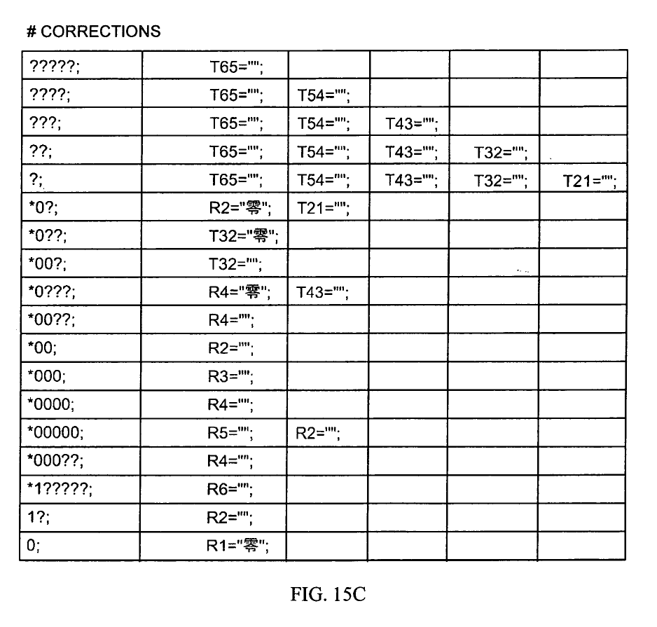

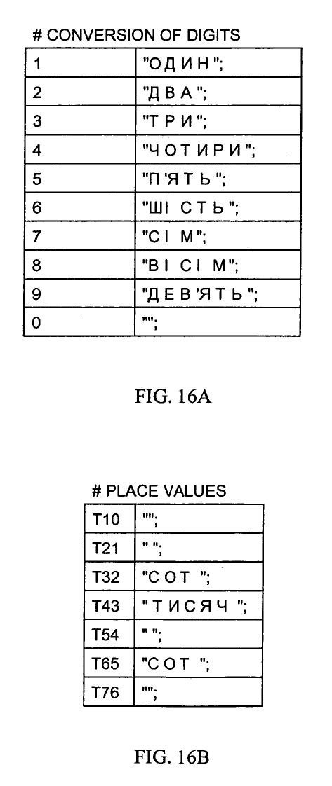

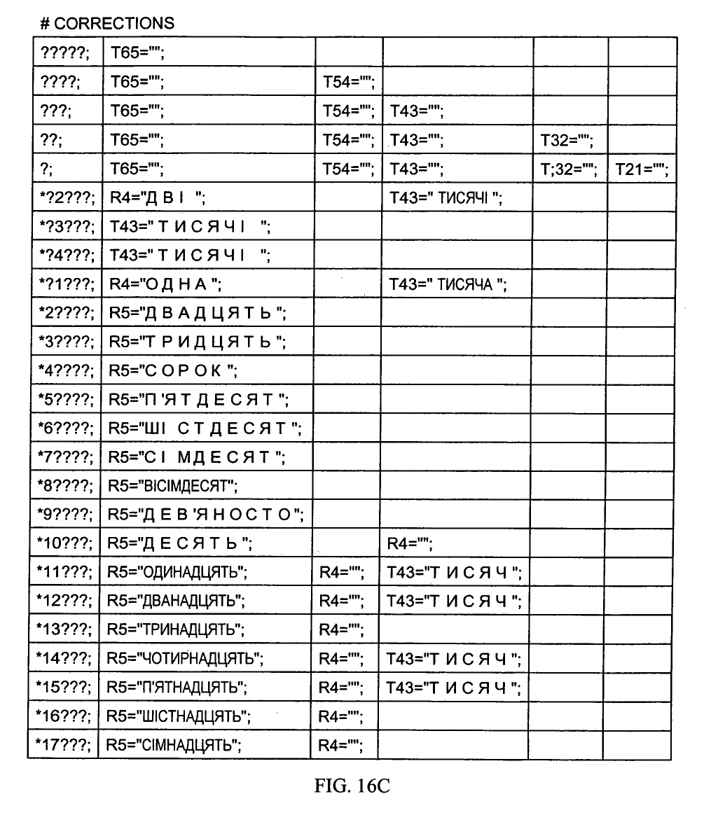

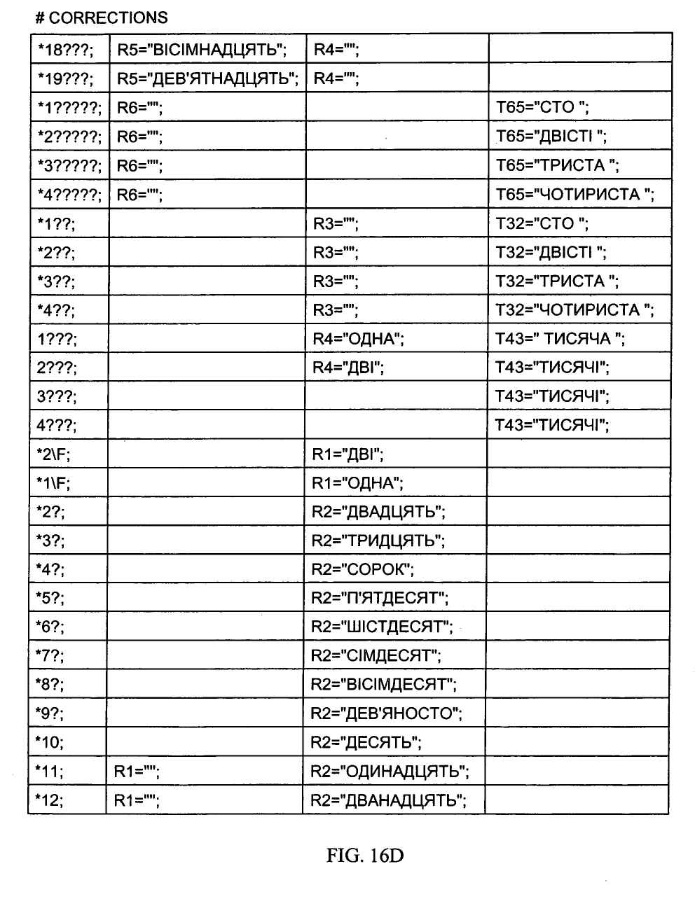

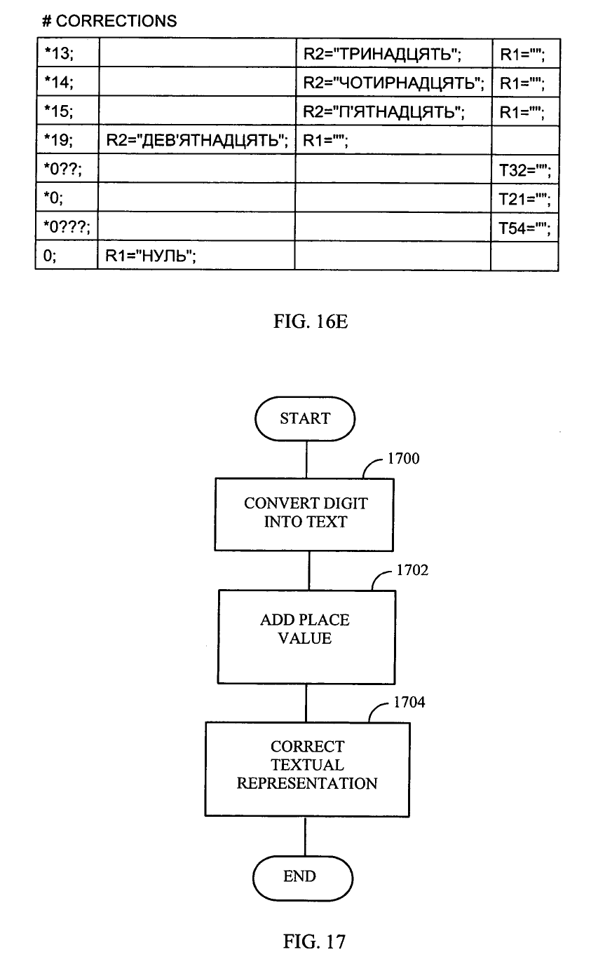

FIG. 16A illustrates conversion of digits into textual representations in Ukrainian. After the conversion, the number becomes

[symbol]

[symbol]

[symbol]

[symbol]

[symbol]

FIG. 16B illustrates addition of place values in Ukrainian. After the addition, the number becomes

[symbol]

[symbol]

[symbol]

[symbol]

[symbol]

[symbol]

[symbol]

[symbol]

[symbol]

FIGS. 16C, 16D and 16E illustrate correction of the textual representations in Ukrainian. The correct form of the number is

[symbol]

[symbol]

[symbol]

[symbol]

[symbol]

[symbol]

[symbol]

[symbol]

[symbol]

[symbol]

In all these languages the tabulated rules can be applied in a manner similar to that of English. Clearly, the same method can be applied to many other languages not mentioned in this application.

FIG. 17 shows a flow chart of the method of converting a number into a textual representation. In step 1700, each digit of the cardinal number is converted, one by one, into a textual representation of a desired language. In step 1702, a textual representation of a place value is added to a textual representation of a digit depending on a place of a digit in the sequence of places ordered by powers of ten is performed. In step 1704, any textual representation formed by and relating to at least one digit in a place known to result in a textual representation differing from a correct expression is corrected on the basis of language-dependent rules defining correct expressions.

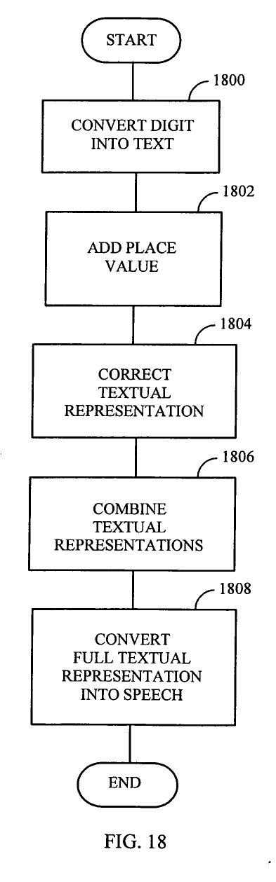

FIG. 18 shows a flow chart of the method of converting a number into speech. In step 1800, each digit of the cardinal number is converted, one by one, into a textual representation of a desired language. In step 1802, a textual representation of a place value is added to a textual representation of a digit depending on a place of a digit in the sequence of places ordered by powers of ten is performed. In step 1804, any textual representation formed by and relating to at least one digit in a place known to result in a textual representation differing from a correct expression is corrected on the basis of language-dependent rules defining correct expressions. In step 1806, the textual representations are combined for forming a full textual representation of the number, if the number has more than one digit, and otherwise the full textual representation of the number is formed using the textual representation of the single digit. In step 1808, the full textual representation of the number is converted into speech.

The embodiments of the invention may be realized in an electronic device comprising a display, a keyboard and a controller operationally connected to the keyboard and the display, for example. The controller may be configured to perform at least some of the steps described in connection with either of the methods shown in FIGS. 17 and 18. The embodiments may be implemented as a computer program comprising instructions for executing a computer process for converting, one by one, each digit of a cardinal number into a textual representation of a desired language; performing the following operation depending on a place of a digit in the sequence of places ordered by powers of ten; adding a textual representation of a place value to a textual representation of a digit; and performing additionally the following operation on the basis of language-dependent rules defining correct expressions; correcting any formed textual representation relating to at least one digit in a place known to result in a textual representation differing from a correct expression.

The embodiments may also be implemented as a computer program comprising instructions for executing a computer process for converting, one by one, each digit of the cardinal number into a textual representation of a desired language; performing the following operation depending on a place of a digit in the sequence of places ordered by powers of ten; adding a textual representation of a place value to a textual representation of a digit; performing additionally the following operation based on language-dependent rules defining correct expressions; correcting any formed textual representation relating to at least one digit in a place known to result in a textual representation differing from a correct expression; combining the textual representations for forming a full textual representation of the number, if the number has more than one digit, and otherwise forming the full textual representation of the number using the textual representation of the single digit; and converting the full textual representation of the number into speech.

Either of the computer programs may be stored on a computer program distribution medium readable by a computer or a processor. The computer program medium may be, for example but not limited to, an electric, magnetic, optical, infrared or a semiconductor system, device or transmission medium. The medium may be a computer readable medium, a program storage medium, a record medium, a computer readable memory, a random access memory, an erasable programmable read-only memory, a computer readable software distribution package, a computer readable signal, a computer readable telecommunications signal, and a computer readable compressed software package.

The application of registers can be used for converting a time expressed in hours and minutes into textual representation. The implementation uses a register including multiple digits. Elements of a transition register, which is similar to a register of place values, are placed between each digit.

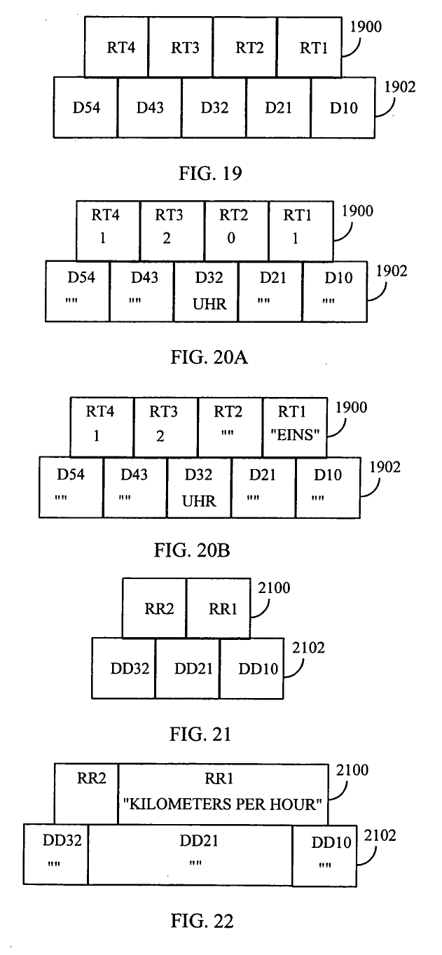

A register set-up is shown in FIG. 19. A number register 1900 includes the time such as 12:35. Then, a register element R4 includes the number “1”, a register element R3 includes the number “2”, a register element R2 includes the number “3” and a register element R1 includes the number “5”. A transition register 1902 includes register elements D54 to D10. The contents of the registers 1900 and 1902 can be combined such that they form a sequence D54 R4 D43 R3 D32 R2 D21 R1 D10. The elements of the transition register 1902 can be used as memories for storing words possibly needed between each digit in a certain language.

In English, a time can be handled, for example, according to the following rules:

| | |
|---|---|
| ??:0? | RT2 = “o”; |
| ??:00 | RT2 = “o'clock”; RT1 = “ ”; |

where ? is a symbol indicating any single digit.

In Finnish, a time can be handled, for example, according to the following rules:

| | |
|---|---|
| ??:0? | RT2 = “nolla”; |
| ??:00 | RT2 = “nolla”; D21 = “‘ ’”; RT1 = “nolla”; |

In German, a time can be handled, for example, according to the following rules:

| ??:?? | D32 = “Uhr”; |
|---|---|
| ??:01 | RT2 = “ ”; RT1 = “eins”; |
| ??:00 | D54 = “genau”; RT2 = “ ”; RT1 = “ ”; |

The syntax can be considered as the following:

<matching criteria>;<register>=
”<string>”|<register>;[<register>=”<string>”|<register>;...],
<matching criteria> = [*] <number>[<number>] ... [<number>],
<number> = ?|0|1|2|3|4|5|6|7|8|9, and
<register> = R1|R2|R3|R4|T54|T43|T32|T21|T10.

FIGS. 20A and 20B show an example of application of rules. A register 1900 includes the time 12:01. In FIG. 20A, after the application of a rule affecting a register element D32, a register 1902 includes the word “Uhr” in a register element D32. The other register elements are set to be empty. Next, the rule relating to “??:01” is applied and hence a register element RT1 in FIG. 20B includes “eins”. A register element RT2 is set to be empty. After applying the number rules presented earlier in the application, the time becomes “zwölf Uhr eins”. In a similar manner, seconds can be processed.

Additionally, abbreviations, such as km, km/h, m, kg, etc., relating to a number can be handled similarly. The implementation uses two main registers: one for a unit and the other for a number associated with the unit. There may also be additional transition register elements in front of the number, between the number and the unit and after the unit. A register set-up is presented in FIG. 21. A register element RR2 in a register 2100 includes the number while the register element RR1 includes the abbreviation. Register elements DD10 to DD32 in a register 2102 may include words necessary for a proper expression. The contents of the registers can be combined such that they form a sequence DD32 RR2 DD21 RR1 DD10. The register element DD21 may be set to “\m”, “\n” or “\f”, where tags may be used to denote masculine (“\m”), neuter (“\n”) or feminine (“\f”). A set of rules needs to be defined to obtain the proper format for each abbreviated unit. The rules can be implemented as a lookup table with some additional capabilities of pattern matching.

The syntax can be considered as the following:

<matching criteria>; <register>=
”<string>”|<register>;[<register>=”<string>”|<register>;...],
<matching criteria> =
[*] <number>[<number>] ... [<number>] [symbol] <unit>,
<number> = ?|0|1|2|3|4|5|6|7|8|9,
<unit> = m|km|yd|mi|kCal|kJ|km/h|min/h|mph|min/mi..., and
<register> = RR1|RR2|DD32|DD21|DD10.

The mark_means a white space.

For example, an expression 453 km/h can be converted into a textual representation in English using the following rules:

| | |
|---|---|
| * km/h | RR1 = “kilometers per hour”; |
| 1 km/h | RR1 = “kilometer per hour”; |

FIG. 22 shows the contents of the registers after detection of a matching rule [* km/h RR1=“kilometers per hour”;]. The output string is then “453 kilometers per hour”. If the gender of the unit “km/h” has an impact on the spoken/written form of the number 453, a gender tag would have been set into a register element DD21 of the register 2102 for the number processing block e.g. “453” “\f” “kilometers per hour”.

Also note that if no white space exists in the beginning of “kilometers per hour”, the output sequence would be “453 kilometers per hour”. The white space can be included into the string as described above, or it can be placed into a transition register element DD21.

Even though the invention has been described above with reference to an example according to the accompanying drawings, it is clear that the invention is not restricted thereto but it can be modified in several ways within the scope of the appended claims.

1. A method of converting a cardinal number of a decimal number system including at least one digit in a sequence of places ordered by powers of ten into a textual representation of a desired language, the method comprising:
converting, one by one, each digit of the cardinal number into a textual representation of a desired language;
performing the following operation depending on a place of a digit in the sequence of places ordered by powers of ten:
adding a textual representation of a place value to a textual representation of a digit; and
performing additionally the following operation in the basis of language-dependent rules defining correct expressions:
correcting any formed textual representation relating to at least one digit in a place known to result in a textual representation differing from a correct expression.

2. The method of claim 1, the method further comprising combining the textual representations for forming a full textual representation of the number if the number has more than one digit, and otherwise
forming the full textual representation of the number using the textual representation of a single digit.

3. The method of claim 1, the method further comprising adding a textual representation of a place value to a textual representation of a digit according to the language-dependent rules defining correct expressions.

4. The method of claim 1, the method further comprising correcting a textual representation of a combination of successive digits of a number including more than one digit in a place known to result in an incorrect expression.

5. The method of claim 1, the method further comprising correcting a textual representation by replacing a textual representation known to be incorrect by a correct textual representation.

6. The method of claim 1, the method further comprising adding a textual representation of a place value behind a textual representation of a digit.

7. The method of claim 1, the method further comprising selecting a desired language from among a plurality of languages for converting the cardinal number into a textual representation.

8. The method of claim 1, the method further comprising correcting the textual representation of the number to a textual representation corresponding to a zero in the desired language if the number is 0.

9. The method of claim 1, the method further comprising searching for the most significant digit to determine a need for place values.

10. The method of claim 1, the method further comprising converting a time expressed in hours and minutes into textual representation.

11. The method of claim 1, the method further comprising converting an abbreviation into textual representation.

12. A method of converting a cardinal number of a decimal number system including at least one digit in a sequence of places ordered by powers of ten into speech of a desired language, the method comprising:
converting, one by one, each digit of the cardinal number into a textual representation of a desired language;
performing the following operation depending on a place of a digit in the sequence of places ordered by powers of ten:
adding a textual representation of a place value to a textual representation of a digit;
performing additionally the following operation on the basis of language-dependent rules defining correct expressions:
correcting any formed textual representation relating to at least one digit in a place known to result in a textual representation differing from a correct expression;
combining the textual representations for forming a full textual representation of the number if the number has more than one digit, and otherwise forming the full textual representation of the number using the textual representation of the single digit; and
converting the full textual representation of the number into speech.

13. A device for converting a cardinal number of a decimal number system including at least one digit in a sequence of places ordered by powers of ten into a textual representation of a desired language, the device comprising:
a converter configured to convert, one by one, each digit of the cardinal number into a textual representation of a desired language;
a combiner configured to add a textual representation of a place value to a textual representation of a digit depending on a place of a digit in the sequence of places ordered by powers of ten; and
a corrector configured to correct, on the basis of language-dependent rules defining correct expressions, any formed textual representation relating to at least one digit in a place known to result in a textual representation differing from a correct expression.

14. The device of claim 13, wherein the corrector is further configured
to combine the textual representations for forming a full textual representation of the number if the number has more than one digit, and otherwise
to form the full textual representation of the number using the textual representation of the single digit.

15. The device of claim 13, wherein the combiner is configured to add the textual representation of the place value to the textual representation of a digit according to the language-dependent rules defining correct expressions.

16. The device of claim 13, wherein the corrector is configured to correct a textual representation of a combination of successive digits of a number including more than one digit in a place known to result in an incorrect expression.

17. The device of claim 13, wherein the corrector is configured to correct a textual representation by replacing a textual representation known to be incorrect by a correct textual representation.

18. The device of claim 13, wherein the combiner is configured to add a textual representation of a place value behind a textual representation of a digit.

19. The device of claim 13, wherein the device comprises a selector configured to select a desired language from among a plurality of languages for converting the cardinal number into a textual representation.

20. The device of claim 13, wherein the corrector is configured to correct the textual representation of the number to a textual representation corresponding to a zero in the desired language if the number is 0.

21. The device of claim 13, wherein the device is configured to search for the most significant digit to determine a need for place values.

22. The device of claim 13, wherein the device is configured to convert a time expressed in hours and minutes into textual representation.

23. The method of claim 13, wherein the device is configured to convert an abbreviation into textual representation.

24. A device for converting a cardinal number of a decimal number system including at least one digit in a sequence of places ordered by powers of ten into a textual representation of a desired language, the device comprising:
means for converting, one by one, each digit of the cardinal number into a textual representation of a desired language;
means for adding a textual representation of a place value to a textual representation of a digit depending on a place of a digit in the sequence of places ordered by powers of ten; and
means for correcting, on the basis of language-dependent rules defining correct expressions, any formed textual representation relating to at least one digit in a place known to result in a textual representation differing from a correct expression.

25. A device for converting a cardinal number of a decimal number system including at least one digit in a sequence of places ordered by powers of ten into speech of a desired language, the device comprising:
a converter configured, one by one, to convert each digit of the cardinal number into a textual representation of a desired language;
a combiner configured to add a textual representation of a place value to a textual representation of a digit depending on a place of a digit in the sequence of places ordered by powers of ten;
a corrector configured
to correct, on the basis of language-dependent rules defining correct expressions, any formed textual representation relating to at least one digit in a place known to result in a textual representation differing from a correct expression, and
to combine the textual representations for forming a full textual representation of the number if the number has more than one digit, and otherwise to form the full textual representation of the number using the textual representation of the single digit; and
a synthesizer configured to convert the full textual representation of the number into speech.

26. A device for converting a cardinal number of a decimal number system including at least one digit in a sequence of places ordered by powers of ten into speech of a desired language, the device comprising:
means for converting, one by one, each digit of the cardinal number into a textual representation of a desired language;
means for adding a textual representation of a place value to a textual representation of a digit depending on a place of a digit in the sequence of places ordered by powers of ten;
means for
correcting, on the basis of language-dependent rules defining correct expressions, any formed textual representation relating to at least one digit in a place known to result in a textual representation differing from a correct expression, and
combining the textual representations for forming a full textual representation of the number if the number has more than one digit, and otherwise to form the full textual representation of the number using the textual representation of the single digit; and
means for converting the full textual representation of the number into speech.

27. A subscriber terminal including a device for converting a cardinal number of a decimal number system including at least one digit in a sequence of places ordered by powers of ten into a textual representation of a desired language, the device comprising:
a converter configured, one by one, to convert each digit of the cardinal number into a textual representation of a desired language;
a combiner configured to add a textual representation of a place value to a textual representation of a digit depending on a place of a digit in the sequence of places ordered by powers of ten; and
a corrector configured to correct, on the basis of language-dependent rules defining correct expressions, any formed textual representation relating to at least one digit in a place known to result in a textual representation differing from a correct expression.

28. A subscriber terminal including a device for converting a cardinal number of a decimal number system including at least one digit in a sequence of places ordered by powers of ten into a textual representation of a desired language, the device comprising:
means for converting, one by one, each digit of the cardinal number into a textual representation of a desired language;
means for adding a textual representation of a place value to a textual representation of a digit depending on a place of a digit in the sequence of places ordered by powers of ten; and
means for correcting, on the basis of language-dependent rules defining correct expressions, any formed textual representation relating to at least one digit in a place known to result in a textual representation differing from a correct expression.

29. A subscriber terminal including a device for converting a cardinal number of a decimal number system including at least one digit in a sequence of places ordered by powers of ten into speech of a desired language, the device comprising:
a converter configured to convert, one by one, each digit of the cardinal number into a textual representation of a desired language;
a combiner configured to add a textual representation of a place value to a textual representation of a digit depending on a place of a digit in the sequence of places ordered by powers of ten;
a corrector configured
to correct, on the basis of language-dependent rules defining correct expressions, any formed textual representation relating to at least one digit in a place known to result in a textual representation differing from a correct expression, and
to combine the textual representations for forming a full textual representation of the number if the number has more than one digit, and otherwise to form the full textual representation of the number using the textual representation of the single digit; and
a synthesizer configured to convert the full textual representation of the number into speech.

30. A subscriber terminal including a device for converting a cardinal number of a decimal number system including at least one digit in a sequence of places ordered by powers of ten into speech of a desired language, the device comprising:
means for converting, one by one, each digit of the cardinal number into a textual representation of a desired language;
means for adding a textual representation of a place value to a textual representation of a digit depending on a place of a digit in the sequence of places ordered by powers of ten;
means for
correcting, on the basis of language-dependent rules defining correct expressions, any formed textual representation relating to at least one digit in a place known to result in a textual representation differing from a correct expression, and
combining the textual representations for forming a full textual representation of the number if the number has more than one digit, and otherwise to form the full textual representation of the number using the textual representation of the single digit; and
means for converting the full textual representation of the number into speech.

31. A computer program product encoding a computer program of instructions for executing a computer process for converting a cardinal number of a decimal number system including at least one digit in a sequence of places ordered by powers of ten into a textual representation of a desired language, the process comprising:
converting, one by one, each digit of the cardinal number into a textual representation of a desired language;
performing the following operation depending on a place of a digit in the sequence of places ordered by powers of ten:
adding a textual representation of a place value to a textual representation of a digit; and
performing additionally the following operation on the basis of language-dependent rules defining correct expressions:
correcting any formed textual representation relating to at least one digit in a place known to result in a textual representation differing from a correct expression.

32. The computer program product of claim 31, the computer program product including at least one of the following: a computer readable medium, a program storage medium, a record medium, a computer readable memory, a computer readable software distribution package, a computer readable signal, a computer readable telecommunications signal, and a computer readable compressed software package.

33. A computer program product encoding a computer program of instructions for executing a computer process for converting a cardinal number of a decimal number system including at least one digit in a sequence of places ordered by powers of ten into speech of a desired language, the process comprising:
converting, one by one, each digit of the cardinal number into a textual representation of a desired language;
performing the following operation depending on a place of a digit in the sequence of places ordered by powers of ten:
adding a textual representation of a place value to a textual representation of a digit;
performing additionally the following operation on the basis of language-dependent rules defining correct expressions:
correcting any formed textual representation relating to at least one digit in a place known to result in a textual representation differing from a correct expression;
combining the textual representations for forming a full textual representation of the number if the number has more than one digit, and otherwise forming the full textual representation of the number using the textual representation of the single digit; and
converting the full textual representation of the number into speech.

34. The computer program product of claim 33, the computer program product including at least one of the following: a computer readable medium, a program storage medium, a record medium, a computer readable memory, a computer readable software distribution package, a computer readable signal, a computer readable telecommunications signal, and a computer readable compressed software package.

35. A computer program distribution medium readable by a computer and encoding a computer program of instructions for executing a computer process for converting a cardinal number of a decimal number system including at least one digit in a sequence of places ordered by powers of ten into a textual representation of a desired language, the process comprising:
converting, one by one, each digit of the cardinal number into a textual representation of a desired language;
performing the following operation depending on a place of a digit in the sequence of places ordered by powers of ten:
adding a textual representation of a place value to a textual representation of a digit; and
performing additionally the following operation on the basis of language-dependent rules defining correct expressions:
correcting any formed textual representation relating to at least one digit in a place known to result in a textual representation differing from a correct expression.

36. The computer program distribution medium of claim 35, the distribution medium including at least one of the following mediums: a computer readable medium, a program storage medium, a record medium, a computer readable memory, a computer readable software distribution package, a computer readable signal, a computer readable telecommunications signal, and a computer readable compressed software package.

37. A computer program distribution medium readable by a computer and encoding a computer program of instructions for executing a computer process for converting a cardinal number of a decimal number system including at least one digit in a sequence of places ordered by powers of ten into speech of a desired language, the process comprising:
converting, one by one, each digit of the cardinal number into a textual representation of a desired language;
performing the following operation depending on a place of a digit in the sequence of places ordered by powers of ten:
adding a textual representation of a place value to a textual representation of a digit;
performing additionally the following operation on the basis of language-dependent rules defining correct expressions:
correcting any formed textual representation relating to at least one digit in a place known to result in a textual representation differing from a correct expression;
combining the textual representations for forming a full textual representation of the number if the number has more than one digit, and otherwise forming the full textual representation of the number using the textual representation of the single digit; and
converting the full textual representation of the number into speech.

38. The computer program distribution medium of claim 37, the distribution medium including at least one of the following mediums: a computer readable medium, a program storage medium, a record medium, a computer readable memory, a computer readable software distribution package, a computer readable signal, a computer readable telecommunications signal, and a computer readable compressed software package.

39. A data structure for converting a cardinal number of a decimal number system including at least one digit in a sequence of places ordered by powers of ten into a textual representation of a desired language, the data structure comprising:
a first data field including information for converting, one by one, each digit of the cardinal number into a textual representation of a desired language;
a second data field including information for adding a textual representation of a place value to a textual representation of a digit depending on a place of a digit in the sequence of places ordered by powers of ten; and
a third data field including information for correcting any formed textual representation relating to at least one digit in a place known to result in a textual representation differing from a correct expression on the basis of language-dependent rules defining correct expressions.

40. A computer program distribution medium readable by a computer, the computer program distribution medium having data structure for converting a cardinal number of a decimal number system including at least one digit in a sequence of places ordered by powers of ten into a textual representation of a desired language, the data structure comprising:
a first data field including information for converting, one by one, each digit of the cardinal number into a textual representation of a desired language;
a second data field including information for adding a textual representation of a place value to a textual representation of a digit depending on a place of a digit in the sequence of places ordered by powers of ten; and
a third data field including information for correcting any formed textual representation relating to at least one digit in a place known to result in a textual representation differing from a correct expression on the basis of language-dependent rules defining correct expressions.

41. A data structure for converting a cardinal number of a decimal number system including at least one digit in a sequence of places ordered by powers of ten into speech of a desired language, the data structure comprising:
a first data field including information for converting, one by one, each digit of the cardinal number into a textual representation of a desired language;
a second data field including information for adding a textual representation of a place value to a textual representation of a digit depending on a place of a digit in the sequence of places ordered by powers of ten;
a third data field including information for correcting any formed textual representation relating to at least one digit in a place known to result in a textual representation differing from a correct expression on the basis of language-dependent rules defining correct expressions,
for combining the textual representations for forming a full textual representation of the number if the number has more than one digit, and otherwise forming the full textual representation of the number using the textual representation of the single digit, and for converting the full textual representation of the number into speech.

42. A computer program distribution medium readable by a computer, the computer program distribution medium having data structure for converting a cardinal number of a decimal number system including at least one digit in a sequence of places ordered by powers of ten into speech of a desired language, the data structure comprising:
a first data field including information for converting, one by one, each digit of the cardinal number into a textual representation of a desired language;
a second data field including information for adding a textual representation of a place value to a textual representation of a digit depending on a place of a digit in the sequence of places ordered by powers of ten;
a third data field including information for correcting any formed textual representation relating to at least one digit in a place known to result in a textual representation differing from a correct expression on the basis of language-dependent rules defining correct expressions,
for combining the textual representations for forming a full textual representation of the number if the number has more than one digit, and otherwise forming the full textual representation of the number using the textual representation of the single digit, and for converting the full textual representation of the number into speech.
